(19) United States
(12) Patent Application Publication
(10) Pub. No.: US 2025/0127188 A1
(43) Pub. Date: Apr. 24, 2025

(54) METHOD FOR INCORPORATING FAT-SOLUBLE INGREDIENT INTO COMESTIBLE PRODUCT, AND PRODUCT RESULTING THEREFROM

(71) Applicant: PERFETTI VAN MELLE BENELUX BV, HK Breda (NL)

(72) Inventors: Zhi Kai See, Singapore (SG); Koichi Enomoto, Singapore (SG)

(73) Assignee: PERFETTI VAN MELLE BENELUX BV, HK Breda (NL)

(21) Appl. No.: 18/687,442

(22) PCT Filed: Aug. 29, 2022
(86) PCT No.: PCT/US2022/041882

§ 371 Date: Feb. 28, 2024

Related U.S. Application Data
(60) Provisional application No. 63/238,342, filed on Aug. 30, 2021.

(51) Int. Cl. A23G 4/12; A23G 4/20

(52) U.S. Cl. CPC A23G 4/126; A23G 4/20

(57) ABSTRACT

Disclosed is a method for incorporating a fat-soluble ingredient into a comestible product, the method including forming a comestible core, coating the comestible core with at least one coating layer to form a comestible shell, and applying a fat-soluble ingredient to the comestible core via the coating, the fat-soluble ingredient being applied in the at least one coating layer in liquid form.

### CROSS-REFERENCE TO RELATED APPLICATION

The present application claims priority benefit to a provisional application which was filed on Aug. 30, 2021, and assigned Ser. No. 63/238,342. The entire contents of the foregoing provisional application is incorporated herein by reference.

### FIELD

The disclosure relates generally to a method for manufacturing a comestible and the comestible product resulting therefrom, and more particularly to a method for manufacturing a comestible with a fat-soluble ingredient and the comestible product resulting therefrom.

### BACKGROUND

Presently, vitamin supplements are typically delivered to consumers in the form of either a liquid, gummy, tablet, or capsule. While these delivery means are sufficient for delivering large doses of vitamins, if/when a consumer remembers to take them, a delivery means more in line with a consumer's day to day routine that delivers smaller, continued doses could have greater nutritional value and be easier to take with regularity.

Confectionery or chewing gum would be a good comestible option as such a vehicle. However, to this point, it has been difficult to sufficiently deliver some vitamins (particularly fat-soluble vitamins) to a user via chewing gum due to the hydrophobic nature of chewing gum base, particularly the elastomer ingredients therein. Accordingly, discovering a way to effectively and consistently release fat-soluble vitamins from a chewing gum would be desirable.

### SUMMARY

According to an embodiment, a method for incorporating a fat-soluble ingredient into a comestible is provided. The method includes forming a comestible core, coating the comestible core with at least one coating layer to form a comestible shell, and applying a fat-soluble ingredient to the comestible core via the coating, the fat-soluble ingredient being applied in the at least one coating layer in liquid form.

In addition to one or more of the features described above, or as an alternative, in further embodiments the comestible core is a chewing gum core.

In addition to one or more of the features described above, or as an alternative, in further embodiments the comestible shell is a hard candy confectionery shell.

In addition to one or more of the features described above, or as an alternative, in further embodiments the at least one coating layer is a plurality of coating layers applied in a plurality of coating steps.

In addition to one or more of the features described above, or as an alternative, in further embodiments the at least one of said plurality of coating steps includes applying a liquid premix of fat-soluble ingredient and at least one flavor ingredient in at least one of the plurality of coating layers.

In addition to one or more of the features described above, or as an alternative, in further embodiments the plurality of coating steps includes at least one initial step forming an interior portion of the comestible shell, at least one intermediate step forming a central portion of the comestible shell, and at least one finishing step forming an exterior portion of the comestible shell.

In addition to one or more of the features described above, or as an alternative, in further embodiments the method further includes the applying said liquid premix including the fat-soluble ingredient and the at least one flavor ingredient via the at least one intermediate step.

In addition to one or more of the features described above, or as an alternative, in further embodiments the method further includes localizing the fat-soluble ingredient in the central portion via the intermediate step.

In addition to one or more of the features described above, or as an alternative, in further embodiments the fat-soluble ingredient is at least one fat-soluble vitamin ingredient.

In addition to one or more of the features described above, or as an alternative, in further embodiments the at least one fat-soluble vitamin ingredient is selected from the group consisting of vitamins A, D, E, and K.

In addition to one or more of the features described above, or as an alternative, in further embodiments the fat-soluble vitamin ingredient is vitamin D.

In addition to one or more of the features described above, or as an alternative, in further embodiments the chewing gum core is hydrophobic and includes an elastomer and a sweetener.

In addition to one or more of the features described above, or as an alternative, in further embodiments the comestible shell is a hydrophilic confectionery shell, wherein the at least one initial step and the at least one finishing step includes applying at least one sugar alcohol to form the confectionery shell.

According to an embodiment, a comestible product including a fat-soluble ingredient is provided. The comestible product includes a comestible core and a comestible shell, wherein the comestible shell including an interior portion, a central portion, and an exterior portion, and wherein the comestible shell includes a concentration gradient, such that the central portion includes a maximum concentration of the fat-soluble ingredient, and the interior portion and the exterior portion include a minimum concentration of the fat-soluble ingredient.

In addition to one or more of the features described above, or as an alternative, in further embodiments the comestible core is a chewing gum core.

In addition to one or more of the features described above, or as an alternative, in further embodiments the comestible shell is a hard candy confectionery shell.

In addition to one or more of the features described above, or as an alternative, in further embodiments the fat-soluble ingredient is a vitamin.

In addition to one or more of the features described above, or as an alternative, in further embodiments the fat-soluble vitamin ingredient is selected from the group consisting of vitamins A, D, E, and K.

In addition to one or more of the features described above, or as an alternative, in further embodiments the fat-soluble vitamin ingredient is vitamin D.

In addition to one or more of the features described above, or as an alternative, in further embodiments the chewing gum core is hydrophobic and includes an elastomer and a sweetener.

In addition to one or more of the features described above, or as an alternative, in further embodiments the hard candy confectionery shell is hydrophilic and includes at least one sugar alcohol.

In addition to one or more of the features described above, or as an alternative, in further embodiments the fat-soluble ingredient is localized in the central portion of the comestible shell.

In addition to one or more of the features described above, or as an alternative, in further embodiments a minimum concentration of the fat-soluble ingredient is in the interior portion and in the exterior portion of said comestible shell, and the maximum concentration of the fat-soluble ingredient is in the central portion of the comestible shell.

In addition to one or more of the features described above, or as an alternative, in further embodiments the minimum concentration of the fat-soluble ingredient in the interior portion and in the exterior portion is as little as 0% and the maximum concentration of the fat-soluble ingredient in the central portion is as much as 100%.

In addition to one or more of the features described above, or as an alternative, in further embodiments the maximum concentration of the fat-soluble ingredient in the central portion of the comestible shell is any percentage of said fat-soluble ingredient in the central portion that is greater than a percentage of the fat-soluble ingredient in the interior portion and the exterior portion individually.

In addition to one or more of the features described above, or as an alternative, in further embodiments the maximum concentration of the fat-soluble ingredient in the central portion of the comestible shell is any percentage of the fat-soluble ingredient in the central that is greater than a combined percentage of the fat-soluble ingredient in the interior portion and the exterior portion.

### BRIEF DESCRIPTION OF THE DRAWINGS

The accompanying drawings incorporated in and forming a part of the specification embodies several aspects of the present disclosure and, together with the description, serves to explain the principles of the present disclosure. In the drawings:

FIG. 1 is a block diagram illustrating a method for incorporating a fat-soluble ingredient into a comestible product;

FIG. 2 is a cross-sectional view of a comestible product according to an embodiment; and

FIG. 3 is a view of a portion of a system for manufacturing a comestible product including a fat-soluble ingredient.

### DETAILED DESCRIPTION

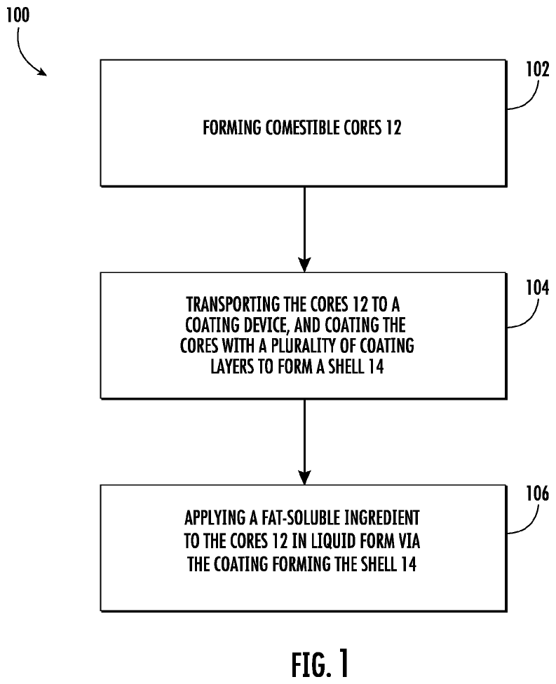

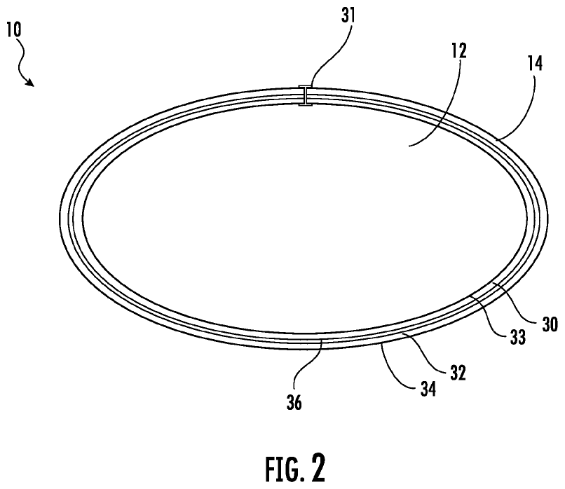

With reference to FIGS. 1-3, a method for incorporating a fat-soluble ingredient into comestible products, and the comestible products resulting therefrom, will be described hereinbelow. As shown at FIG. 2, an exemplary comestible product 10 includes a core 12 and a shell 14. As will be discussed in detail below, the comestible product 10 includes one or more fat-soluble ingredients, such as a fat-soluble active ingredient, such as a vitamin, incorporated into the shell 14. Some examples of the fat-soluble vitamin ingredient that may be used are vitamins A, D, E, and K, and particularly vitamin D.

In an exemplary embodiment, the comestible product 10 is a confectionery product, with the comestible core 12 being a confectionery core and the comestible shell 14 being a confectionery shell. Some types of exemplary confectioneries used will be discussed in more detail below. The term “confectionery product” as used herein is intended to include any edible product comprising a sweet component. Confectionery products may be made with sugar, syrup, sugar alcohol, honey, and sweet foods, such as candy or pastry for example. Confectionery compositions are well known in the art and include soft candy, chewy candy, hard candy, chewing gum, chocolate (including milk chocolate, dark chocolate, white chocolate, and semi-sweet chocolate for example), and lozenges, etc.

In an exemplary embodiment, one type of the confectionery product 10 considered for use is chewing gum, specifically coated chewing gum pellet. For each product or pellet 10 manufactured in accordance with the method described below, the core may be a chewing gum core 12, and the shell may be a hard or soft candy shell 14. The chewing gum core 12 may include any water-insoluble or hydrophobic gum base well known in the art. Illustrative examples of suitable polymers for gum bases include, but are not limited to, natural and synthetic elastomers and rubbers. The gum base composition of the core 12 may also include elastomer solvents to aid in softening the gum base, as well as a variety of other traditional base ingredients such as plasticizers or softeners, emulsifiers, and bulking agents. In addition to gum base, the core 12 may include natural and/or artificial bulk sweeteners, as well as flavorant and colorant. The elastomers in the gum base composition of the core 12 are typically long chain or large molecular weight compounds that are hydrophobic. The gum base composition includes about 20% to 50% by weight of the elastomer, and the gum product includes about 15% to 40% of the gum base; thus the chewing gum core 12 includes about 3% to 20% of the hydrophobic elastomers. The gum core 12 also includes resin, wax, and softeners which are also hydrophobic. These hydrophobic ingredients create an environment in the core 12 with hydrophobic conditions sufficient enough to absorb or trap fat-soluble ingredients. Indeed, as the gum cores 12 are masticated, any or at least most of the hydrophilic ingredients that may be present in the core are dissolved by saliva and ingested. This leaves behind a gum bolus, which is all or almost all hydrophobic base materials, such as elastomer, which can absorb or trap the fat-soluble ingredients whether they were added to the core mixture with the hydrophobic gum base ingredient or ingestible hydrophilic ingredient.

In an exemplary embodiment, the hard candy shell 14 of the product 10 also includes a number of traditional ingredients in addition to the fat-soluble ingredient. Ingredients such as but not limited to polyols or sugar alcohols, as well as flavors, colors and binders such as but not limited to starch or gum arabic may be included in the shell 14. With reference to FIG. 1 in particular, a description of the method 100 for forming the product 10 is set forth below.

With reference to method step 102, the method 100 begins with formation of cores 12, in this exemplary embodiment confectionery or chewing gum cores 12. The cores 12 may be formed via any traditional batch or continuous mixing/extruding process. In an exemplary embodiment presented for illustrated purposes, gum base may be pelletized and placed in a standard mixer or extruder. An emulsifier for the gum base, if desired, may be added to the mixer/extruder and mixed in with the gum base. Polyol and glycerin may also be added to the mixer/extruder to be thoroughly mixed in with the gum base. In addition, flavorant, colorants, active materials, sweeteners and any other additives may be added to the mixture/extruder and incorporated into the gum core material. The final chewing gum composition is then discharged from the mixer/extruder, and shaped/formed into chewing gum cores 12 via a pelletizer or forming dies.

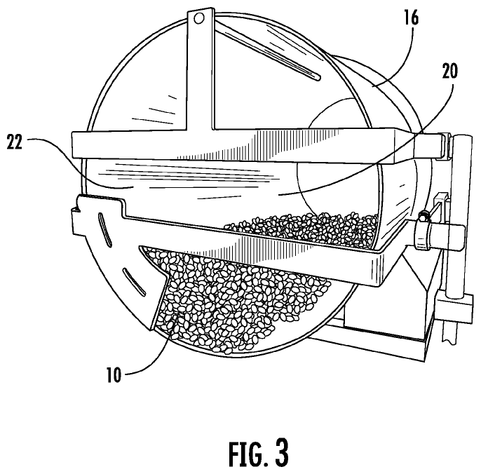

Once pelletized, the cores 12 may be transported to a traditional coating device, such as coating drum 16 as shown in FIG. 3. With reference to method step 104, the cores 12 are coated in a coating device(s), such as drum 16, wherein a plurality of coating layers are applied to the cores 12 to form the shells 14, which are, in this exemplary embodiment, confectionery shells 14. Any traditional mechanism may be used for executing the coating process, such as spray nozzles or bars (not shown) and rotation of coating drum 16. To the extent powders (such as polyol powders) are used in this coating process they may simply be added to the drum cavity 20 via opening 22 or any other traditional means for mixing with the cores 12.

The hard candy shell 14 of this exemplary embodiment, which is primarily (if not all) a hydrophilic ingredient and thus creating a hydrophilic environment, may be added to the cores 12 in a plurality of coating layers. Indeed, in an exemplary embodiment, the entire coating process may include 10-100 coating steps, and more particularly 20-90 steps, 30-80 steps, 40-70 steps, 40-60 steps, 40-50 steps, or 50-60 steps. A plurality of coating layers may be added via these coating steps with a plurality of coating layers, such that the coating 14 is added via 20-90 layers, 30-80 layers, 40-70 layers, 40-60 layers, 40-50 layers, or 50-60 layers applied to the chewing gum cores 12. Each step may involve the addition of a layer, followed by a period of time for drying. With reference to method step 106, the fat-soluble ingredient, in this exemplary embodiment a fat-soluble vitamin ingredient, is applied to the gum cores 12 in liquid form via at least one of coating step that forms at least one coating layer of the hard candy shell 14.

In an exemplary embodiment, the plurality of overall coating steps for applying the hard candy shell 14 to the chewing gum cores 12 may be broken down into three general steps or phases. A first or initial phase involves applying one or more desired sugar alcohols (see some examples above) to the chewing gum cores 12 in the coating drum 16. The spray nozzles or bars 18 deliver a sugar alcohol solution to the cores 12, while the rotation of the drum 16 disperses the solution about the cores 12 allowing each to be fully coated. A binding agent such as gum arabic may also be included in the solution to assist the sugar alcohol solution in binding to the cores 12. In an exemplary embodiment, the coating steps involved in this initial phase may include 1-50 coating steps, and more particularly 5-50, 10-45, 15-40, 20-35, 20-30, or 20-25 coating steps, and even more particularly at least or as many as 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 coating steps.

Following the initial phase (and perhaps after an additional or extended time period for drying/conditioning), a second or intermediate phase in the plurality of overall coating steps is initiated. During the intermediate phase a liquid premix including fat-soluble vitamin ingredient is applied to the coating layer or layers on the cores 12 from the initial phase (also referred to as initially coated cores). The liquid premix may include a fat-soluble vitamin ingredient and a flavor ingredient, or may consist essentially of the fat-soluble vitamin ingredient and the flavor ingredient. The liquid premix is applied to the initially coated cores 12 in the coating drum 16, or in an additional/downstream coating drum (not pictured) to which the initially coated cores 12 have been transported. The spray nozzles or bars deliver the liquid premix to the initially coated cores 12, while the rotation of the drum 16 disperses the solution about the initially coated cores 12 allowing each to be fully coated with the liquid premix. In an exemplary embodiment, the coating steps in the intermediate phase may include 1-35 coating steps following the initial phase, and more particularly 1-2, 1-4, 2-3, 2-4, 1-30, 2-30, 3-30, 4-30, 1-25, 2-25, 3-25, 4-25, 1-20, 2-20, 3-20, 4-20, 1-15, 2-15, 3-15, 4-15, 1-10, 2-10, 3-10, 4-10 or 5-10 coating steps, and even more particularly at least or as many as 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or 35 coating steps.

Following the intermediate phase (and perhaps after yet another additional or extended time period for drying/conditioning), a third or finishing phase in the plurality of overall coating steps is initiated. During the finishing phase a sugar alcohol solution is again applied to the coating layers on the cores 12 from the initial and the intermediate phases (the latter is also referred to as intermediate coated cores). Here again, the sugar alcohol solution delivered in the finishing phase is applied to the initially and the intermediate coated cores 12 in the coating drum 16, or additional/downstream coating drum (not pictured) to which the initially and the intermediate coated cores 12 have been transported. The spray nozzles or bars again deliver the sugar alcohol solution to the initially and the intermediate coated cores 12, while the rotation of the drum 16 disperses the solution about the initially and the intermediate coated cores 12 allowing each to be fully coated with the sugar alcohol solution. In an exemplary embodiment, the coating steps in the finishing phase may include 1-50 coating steps following the initial and the intermediate phases, and more particularly 5-50, 10-45, 15-40, 20-35, 20-30, or 20-25 coating steps, and even more particularly at least or as many as 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 coating steps.

Referring specifically now to FIG. 2, the above discussed initial, intermediate, and finishing phases create a comestible product 10 that includes three different portions throughout an overall thickness 31 of the shell 14. The portions include an interior portion 30 located at an interface with and nearest to a surface 33 of a comestible core 12, an exterior portion 32 located at and nearest a surface 34 of the overall comestible product 10, and a central portion 36 located between the interior portion 30 and the exterior portion 32. The process results in a comestible product, or in an exemplary embodiment a confectionary product 10, that has a core 12 with sufficient enough hydrophobic conditions to absorb or trap a fat-soluble ingredient, surrounded by a shell 14 that is at least a majority hydrophilic. The shell 14 includes a concentration gradient of a fat-soluble ingredient with a maximum concentration of the fat-soluble ingredient in the central portion 36 of the shell 14 and a minimum concentration of the fat-soluble ingredient at the interior and the exterior portions 30, 32 of the shell 14.

It should be appreciated that, in an exemplary embodiment, the minimum concentration of the fat-soluble ingredient in the interior and exterior portions 30, 32 as discussed above is as little as 0%, and the maximum concentration of the fat-soluble ingredient in the central portion 36 as discussed above is as much as 100%. In further exemplary embodiments, the above discussed maximum concentrations of fat-soluble ingredient in the central portion 36 of the shell 14 may be at least 34%, at least 50%, at least 67%, and at least 75%. In still further exemplary embodiments the above discussed maximum concentrations of fat-soluble ingredient in the central portion 36 of the shell 14 may be at least 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, and 99%. As noted above the maximum concentration of the fat-soluble ingredient in the central portion 36 may is as much as 100%. Indeed, in an exemplary embodiment, the maximum concentration of the fat-soluble ingredient in the central portion 36 as discussed above is any percentage whereby the central portion 36 includes a greater concentration than the concentration of each of the interior portion 30 and exterior portion 32 individually, or includes a greater concentration than the combined concentration of the interior portion 30 and exterior portion 32.

Similarly, in exemplary embodiments the above discussed minimum concentrations of fat-soluble ingredient in in each of the interior portion 30 and exterior portion 32 of the shell 14 may be at most 33%, at most 25%, at most 20%, and at most 10%. In still further exemplary embodiments the above discussed minimum concentrations of fat-soluble ingredient in each of the interior portion 30 and exterior portion 32 of the shell 14 may be at most 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4%, 3%, 2%, and 1%. As noted above the minimum concentrations of fat-soluble ingredient in each of the interior portion 30 and exterior portion 32 of the shell 14 may is as little as 0%.

As discussed, due to application of the fat-soluble liquid premix at the intermediate phase, the fat-soluble ingredient will be present and essentially localized in the central portion 36 of the shell 14. This is beneficial to effective and consistent release of the fat-soluble ingredient due to provided distances from and barriers between the gum core 12 via the interior portion 30, and the overall product surface 34 via the exterior portion 32. Indeed, if the fat-soluble ingredient did not have this effective distance and barrier from the gum core 12 via the interior portion 30, the fat-soluble ingredient would be at risk of being absorbed by the hydrophobic gum core 12, which would diminish effective and consistent release of the fat-soluble ingredient during mastication. In addition, if the fat-soluble ingredient did not have this effective distance and barrier from the gum surface 34 via the exterior portion 32, the fat-soluble ingredient would be at risk of being oxidized by ambient exposure, which would also diminish the amount of fat-soluble ingredient available for release during mastication and potentially degrade its color.

Though the figures may not be to scale (and the pellet 10 may be of any shape), it should be noted that the central portion 36 of the shell 14 may be about a third of the thickness 31 of the shell, and more particularly 1-35% of the thickness 31 of the shell 14, and still more particularly about 1-2%, 1-4%, 2-3%, 2-4%, 1-30%, 2-30%, 3-30%, 4-30%, 1-25%, 2-25%, 3-25%, 4-25%, 1-20%, 2-20%, 3-20%, 4-20%, 1-15%, 2-15%, 3-15%, 4-15%, 1-10%, 2-10%, 3-10%, 4-10% or 5-10% of the thickness 31 of the shell 14, and even more particularly at least or as much as about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35% of the thickness 31 of the shell 14. The interior portion 30 may be about a third of the thickness 31 of the shell, and more particularly may be about 1-35% or 1-50% of the thickness 31 of the shell 14, and still more particularly about 5-50%, 10-45%, 15-40%, 20-35%, 20-30%, or 20-25% of the thickness 31 of the shell 14, and even more particularly at least or as much as about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, or 50% of the thickness 31 of the shell 14. The exterior portion 32 may be about a third of the thickness 31 of the shell, and more particularly may be about 1-35% or 1-50% of the thickness 31 of the shell 14, and still more particularly about 5-50%, 10-45%, 15-40%, 20-35%, 20-30%, or 20-25% of the thickness 31 of the shell 14, and even more particularly at least or as much as about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, or 50% of the thickness 31 of the shell 14.

### Example

In order to test and detect presence of an effective and consistent release of a fat-soluble vitamin ingredient from the coated gum product 10, a method designed to simulate human mastication of the coated chewing gum was employed. Such a method included soaking ˜10 g of coated gum product 10 in 200 ml of 37° C. water, and storing the product in an incubator at 37° C. for 16 hours. The soaked product was extracted using a stomacher for 15 minutes and filtered through a filter paper (No. 5A, Toyo Roshi Kaisha, Ltd.), and the fat-soluble vitamin ingredient concentration analyzed by gas chromatography or some equivalent method.

Having carried out the above test for a gum product 10 produced by the above discussed method 100, it was found that release of the fat-soluble vitamin ingredient was consistent and acceptable, with 20% to 35% of the fat-soluble vitamin ingredient added at the coating step 106 being detected/released. Indeed, when 168 μg of vitamin per 100 g of product was applied via coating step 106, the test yielded a detected/released about 33 μg of vitamin per 100 g of product to 59 μg of vitamin per 100 g of product.

This written description uses examples to disclose the invention, including the best mode. The examples are also used to enable any person skilled in the art to make and use the invention. It should be appreciated that the patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All of the ranges disclosed herein are inclusive of the endpoints, and the endpoints are independently combinable with each other. It should be appreciated that each range disclosed herein constitutes a disclosure of any point or sub-range lying within the disclosed range.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

What is claimed is:

1. A method for incorporating a fat-soluble ingredient into a comestible product, the method comprising:
forming a comestible core;
coating said comestible core with at least one coating layer to form a comestible shell; and
applying a fat-soluble ingredient to said comestible core via said coating, said fat-soluble ingredient being applied in said at least one coating layer in liquid form.

2. The method of claim 1, wherein said comestible core is a chewing gum core.

3. The method of claim 1, wherein said comestible shell is a hard candy confectionery shell.

4. The method of claim 1, wherein said at least one coating layer is a plurality of coating layers applied in a plurality of coating steps.

5. The method of claim 4, wherein at least one of said plurality of coating steps comprises applying a liquid premix of said fat-soluble ingredient and at least one flavor ingredient in at least one of said plurality of coating layers.

6. The method of claim 5, wherein said plurality of coating steps comprises at least one initial step forming an interior portion of said comestible shell, at least one intermediate step forming a central portion of said comestible shell, and at least one finishing step forming an exterior portion of said comestible shell.

7. The method of claim 6, further including applying said liquid premix comprising said fat-soluble ingredient and said at least one flavor ingredient via said at least one intermediate step.

8. The method of claim 7, further comprising localizing said fat-soluble ingredient in said central portion.

9. The method of claim 1, wherein said fat-soluble-ingredient is at least one fat-soluble vitamin ingredient.

10. The method of claim 9, wherein said fat-soluble vitamin ingredient is selected from the group consisting of vitamins A, D, E, and K.

11. The method of claim 10, wherein said fat-soluble vitamin ingredient is vitamin D.

12. The method of claim 2, wherein said chewing gum core is hydrophobic and comprises an elastomer and a sweetener.

13. The method of claim 5, wherein said comestible shell is a hydrophilic confectionery shell, and wherein at least one of said initial step and said finishing step comprises applying at least one sugar alcohol to form said confectionery shell.

14. A comestible product comprising a fat-soluble ingredient, the product comprising:
a comestible core; and
a comestible shell coating said comestible core,
wherein said comestible shell comprises an interior portion, a central portion, an exterior portion, and
a fat-soluble ingredient;
wherein said comestible shell comprises a concentration gradient, such that said central portion comprises a maximum concentration of said fat-soluble ingredient, and said interior portion and said exterior portion comprise a minimum concentration of the fat-soluble ingredient.

15. The product of claim 14, wherein said comestible core is a chewing gum core.

16. The product of claim 14, wherein said comestible shell is a hard candy confectionery shell.

17. The product of claim 14, wherein said fat-soluble ingredient is a vitamin.

18. The product of claim 17, wherein said fat-soluble vitamin ingredient is selected from the group consisting of vitamins A, D, E, and K.

19. The product of claim 18, wherein said fat-soluble vitamin ingredient is vitamin D.

20. The product of claim 15, wherein said chewing gum core is hydrophobic and comprises an elastomer and a sweetener.

21. The product of claim 16, wherein said hard candy confectionery shell is hydrophilic and comprises at least one sugar alcohol.

22. The product of claim 14, wherein said fat-soluble ingredient is localized in said central portion of said comestible shell.

23. The product of claim 14, wherein said minimum concentration of said fat-soluble ingredient in said interior portion and said exterior portion of said comestible shell is about 0%, and wherein said maximum concentration of said fat-soluble ingredient in said central portion of said comestible shell is about 100%.

24. The product of claim 14, wherein said maximum concentration of said fat-soluble ingredient in said central portion of said comestible shell is any percentage of said fat-soluble ingredient in said central portion that is greater than a percentage of said fat-soluble ingredient in said interior portion and said exterior portion individually.

25. The product of claim 14, wherein said maximum concentration of said fat-soluble ingredient in said central portion of said comestible shell is any percentage of said fat-soluble ingredient in said central that is greater than a combined percentage of said fat-soluble ingredient in said interior portion and said exterior portion.
